(19) United States
(12) Patent Application Publication
(10) Pub. No.: US 2020/0153956 A1
(43) Pub. Date: May 14, 2020

(54) A SYSTEM FOR CONTEXTUALLY PREVENTING USE OF A MOBILE DEVICE

(71) Applicant: SEGOL 4LIFE LTD., Ra'anana (IL)

(72) Inventor: Avraham MAIMON, Sharsheret (IL)

(21) Appl. No.: 16/617,118

(22) PCT Filed: May 28, 2017
(86) PCT No.: PCT/IL2018/050581

§ 371 Date: Nov. 26, 2019

(30) Foreign Application Priority Data
May 28, 2017 (IL) 252551
Oct. 30, 2017 (IL) 255322

(51) Int. Cl. H04M 1/725; H04W 12/08; H04W 12/00; H04W 48/04; G06F 21/62

(52) U.S. Cl. CPC H04M 1/72577; H04W 12/08; G06F 2221/2149; H04W 48/04; G06F 21/629; H04W 12/00503

(57) ABSTRACT

A system for contextually restricting use of features and software applications of a mobile device with a touchscreen, which comprises a dedicated monitoring unit (MU) configured to communicate wirelessly with the mobile device; and a dedicated software application (app) for mobile devices, installed in advance on the mobile device. The dedicated software application is adapted to connect wirelessly and communicate with the MU; and when the mobile device is in a context that is forbidden according to a predefined enforcement policy, block features and applications of the mobile device, by disabling interaction capability via the touchscreen.

### FIELD OF THE INVENTION

The present invention relates to the field of mobile computerized devices. More particularly, the invention relates to a system for disabling applications and features of a mobile device with a touchscreen according to the context in which it is being used.

### BACKGROUND OF THE INVENTION

In the modern era, mobile computerized devices (e.g. smartphones and tablet devices, hereinafter ‘mobile devices’) enable a user to perform a vast range of operations therewith. Usually, performing operations on such devices involves occupying the user's attention. While in some cases this is permissible and maybe even desirable, there are times when distracting a user's attention to the mobile device may be hazardous, let alone lethal.

For instance, a major cause of vehicular accidents is the use of mobile devices while driving. Using a mobile device distracts a driver's attention from being highly aware to the surroundings of the vehicle, which can cause a long response time to events that require immediate action, e.g., braking or shifting of the steering wheel away from hazard. According to modern studies, the main cause of distractions in mobile devices is data content, e.g., text messages and pictures, while phone conversations generally cause less distraction.

Although several countries have passed laws prohibiting the use of mobile devices during driving, the tendency of mobile device users to look away from the road to the mobile device is difficult to overcome.

Several technological solutions currently exist, which prompt drivers not to use mobile devices. Some solutions are delivered by the cellular service provider of the mobile device, where cellular communication is blocked at the server stage. A unit installed in a vehicle detects, according to location changes, when the vehicle is in motion. The unit reports to the server, which attempts to detect the identity of the vehicle driver using a software application. Accordingly, the server associates the location of the vehicle with the location of the mobile device. As long as the vehicle is in motion cellular communication is disabled by the server.

These systems suffer from complexity, requiring disablement by the cellular service provider. Moreover, disabling cellular communication by the server requires the server to accumulate all the data that was addressed to the mobile device and, once the disablement is ceased, to send the data to the mobile device.

Furthermore, while the use of various features related to data communication is forbidden and considered distracting, the use of other features (such as conducting a phone call or using a navigation software application) is allowed and not considered distracting. In order to use these features, however, one is typically required to physically use the mobile device, and therefore distract attention from driving and from the road.

Another field of mobile device operation restriction includes usage of a mobile device for adverse operations at work places and hours, such as reading news, gaming and using social networks. Ongoing usage during work affects productivity and in some cases even affects the safety of the workers (e.g. in factories where dangerous machinery is used) or creates a security breach (in secure workplaces like government, military facilities).

Nevertheless, some operations performed using mobile devices at work hours and places aren't necessarily adverse, such as contacting a co-worker or emergency calls. Moreover an employer may wish to selectively allow features and not totally restrict use of mobile devices.

It would be advantageous to have a system capable of restricting use of mobile devices at predetermined circumstances and contexts. It is therefore an object of the present invention to provide such a system.

It is another an object of the present invention to provide a system for restricting and/or preventing access of a mobile device user to data content received while driving a vehicle that does not require blocking and accumulating data.

It is yet another object of the invention to provide a system for circumstantially (i.e. depending on time, place, etc.) restricting and/or preventing operations on a mobile device.

It is still another object of the invention to provide a system for selectively restricting and/or preventing operations on a mobile device while selectively allowing other operations.

Other objects and advantages of the invention will become apparent as the description proceeds.

### SUMMARY OF THE INVENTION

A system for contextually restricting use of features and software applications of a mobile device with a touchscreen, which comprises:

a. a dedicated monitoring unit (MU) configured to communicate wirelessly with the mobile device; and
b. a dedicated software application (app) for mobile devices, installed in advance on the mobile device, the dedicated software application is adapted to:
b.1) connect wirelessly to, and communicate with the MU; and
b.2) when the mobile device is in a context that is forbidden according to a predefined enforcement policy, block features and applications of the mobile device, by disabling interaction capability via the touchscreen.

The enforcement policy may be determined by a system administrator, the enforcement policy comprising forbidden features and/or forbidden software applications of the mobile device, and forbidden context for each forbidden feature and/or software application.

The system may further comprise a server, configured to receive and send indications from and to the MU and the app.

The touchscreen of a mobile device may be blocked by displaying an overlay on the touchscreen on top of all other windows, the overlay configured to intercept and block the inputs resulting from any touch of the touchscreen of the mobile device.

The color of the overlay may be dark, thereby blocking visual display of any other application from running on the mobile device screen.

In cases that a non-restricted feature or application is active, the overlay may be transparent, thereby allowing visual view of the non-forbidden feature or application.

Non-restricted features and software applications of the mobile device may be accessible via an icon displayed on the overlay.

In one aspect, the app comprises:
a. an activity component being the graphical user interface, configured to allow the user to login to, and logout out of the system, and register to the system;
b. a service component, configured to manage the touchscreen blocking and connecting to the MU; and
c. a broadcast receiver component, configured to communicate with the MU.

After the mobile device is rebooted, the application automatically restarts and connects to the MU.

Communication between the software app and the MU may be Bluetooth communication.

The MU may comprise a processing unit that runs a software program adapted to pair with mobile devices that run the app.

The MU may comprise a processing unit that runs a software program adapted to communicate with the remote server.

The forbidden context may be selected from the following:
motion of a vehicle in which the user moves;
predetermined working hours of the user.

The enforcement policy may determine that the restricted use is associated with data content.

In one aspect, the system comprises:
a. a dedicated Monitoring Unit (MU) located inside the vehicle and configured to communicate wirelessly with the mobile device; and
b. a dedicated software application (app) for mobile devices, installed in advance on the mobile device and adapted to connect wirelessly and communicate with the MU and to block features and applications of the mobile device,
wherein upon receiving data from the MU indicating that the vehicle is in motion, the software application blocks the touchscreen of the mobile device from displaying predetermined data to, and from receiving inputs from, the user.

Navigation and dialing software applications and features may be allowed, when being in forbidden context.

The MU may comprise a GPS receiver, a cellular communication module, a Bluetooth communications element and a processing unit.

The processing unit may run a software program adapted to pair with mobile devices that run the app, communicate with the remote server, and send GPS data to a connected and paired mobile device.

The forbidden context may be locations throughout a workspace and/or specific work hours.

### BRIEF DESCRIPTION OF THE DRAWINGS

In the drawings:

FIG. 1 shows a graphical overlay displayed on the screen of a mobile device according to an embodiment;

FIG. 2 shows a flowchart describing a screen block management process according to an embodiment;

FIG. 3 shows a flowchart describing processing of a single data message by a software application according to an embodiment;

FIG. 4 shows a flowchart describing the logic flow of the broadcast receiver component after a mobile device is rebooted according to an embodiment; and

FIG. 5 illustrates a mobile device display at various operation states of the system according to an embodiment.

### DETAILED DESCRIPTION OF THE INVENTION

Reference will now be made to an embodiment of the present invention, examples of which are provided in the accompanying figures for purposes of illustration only. One skilled in the art will readily recognize from the following description that alternative embodiments of the structures and methods exemplified herein may be employed, mutatis mutandis, without departing from the principles of the invention.

A system for circumstantially restricting, preventing and disabling features and software applications of a touchscreen mobile device comprises a software application for mobile devices (app) and a dedicated Monitoring Unit (MU). The MU and the application communicate with each other via wireless communication, (e.g. Bluetooth, Bluetooth Low Energy (BTLE), Wi-Fi, etc.) and with a remote server, which is also part of the system.

According to an embodiment, the system is adapted to disable features of a touchscreen mobile device of a vehicle driver while the vehicle is moving, thereby preventing distractions of drivers due to mobile device usage. In this embodiment, the MU is located in the vehicle and is configured to detect that whether the vehicle is in motion (therefore enforcing disablement of the touchscreen), or is stationary.

According to another embodiment, the system is adapted to prevent employees from using their mobile devices during work hours for unnecessary uses (e.g., browsing, reading news, social network interaction, etc.) and to limit the usage time of their mobile devices to, for instance, break hours. According to an embodiment of the invention, an employer may install one or more MUs among the workspace of an office and demand each employee to install the app on the employee's personal mobile device. Consequently, the employer is able to cause the employees not to use the mobile device during work hours. Furthermore, when integrated in the workspace of an office, the system may be configured, so as to work in collaboration with the office's work hour management system. By doing so, employees can be encouraged, or even forced, to activate the app by determining that, for instance, only as long as an employee has the app installed and activated on his mobile device the work hours are registered. At times that the app isn't activated, the employee is considered to be on a break or out of the office.

According to yet another embodiment, the system is a security means in a factory, where heavy and/or sensitive machinery is used. Such a case requires machinery operators and supervisors to constantly be aware to occurrences, and therefore use of a mobile device for any use is forbidden. According to an embodiment of the invention, one or more MUs can be installed throughout the factory in addition to the app being installed on the personal mobile device of each factory worker. Consequently, the factory workers are incapable of using their mobile devices in times that such use is hazardous for the worker or for the production of the factory.

According to still another embodiment, the system is a security means in a security facility, where sensitive information must be kept away from the eyes/ears of the world outside the facility. Such a case requires imaging or recording devices to be absolutely disabled in certain sensitive areas. According to an embodiment of the invention, one or more MUs can be installed throughout the facility in addition to the app being installed on the personal mobile device of each person with access to sensitive information. Consequently, sensitive information is safe from imaging and recording using personal mobile devices of facility workers.

It is noted that with technology advance and modern electronic warfare, it is possible to maliciously take over a mobile device and use features thereof (e.g. imaging and/or recording capabilities). Disabling such features is vital in the case of security facilities, so as to ensure that no mobile device is exploited for such warfare and malicious actions.

It is further noted that the above embodiments were brought for sake of illustration only. It is obvious that the system of the present invention may be used for many other uses besides the above illustrated use-cases, such as homes, cinemas, public transportation and generally any other environment where the use of one or more features of mobile devices is to be restricted.

In order to ensure continual operation of the system and of the mobile device feature restricting, the app is configured to enforce a constantly active wireless communication between the mobile device and the MU. In order to do so, the app constantly seeks for wireless connection to an MU. If an MU is detected, communication is established between the application and the MU. During the communication between the app and the MU, a usage policy is enforced by the two (i.e., the app and the MU), in which several functions of the mobile device are disabled according to criteria set by an administrator.

According to an embodiment, if there is an active internet connection and the user enabled the setting, then instead of performing a regular search for the MU, Bluetooth device is searched for only when instructed to do so by the remote server. The service queries the server periodically (e.g. once every 15 seconds) to check if there is an active MU, i.e. an MU that was previously connected to the application. If there is such an MU, its International Mobile Equipment Identity (IMEI) is fetched from the server and is searched for.

In some embodiments, in order to have a one-to-one identification between an MU and an environment, an additional single search for Bluetooth devices is performed after an MU is found. The goal is to identify any Bluetooth MAC address in the environment (e.g., in the vehicle or in the factory) and to send it to the server, thereby creating a unique MU-environment pair. Along the description the term “pair” is used to describe a connection established between elements of the system, e.g. between the MU and the software application.

### Software Application

The software application (app) comprises three main components:
1. Activity—a graphical user interface (GUI) that allows a user to log in and out of the system, register and set several basic settings;
2. Service—a component that executes most of the logic that is essential to achieve the goal of the app. The service component ensures enforcement of the logic even at times that the app is not activated (i.e. connects to the MU automatically).
3. Broadcast Receiver—this component is used communicated with the MU, to restart the service component after system reboot, and to ensure enforcement of the logic even at times that the device is rebooted during operation of the app.

It is noted that the user is required to be logged in to the system for the service component to operate and be restarted after reboot of the mobile device.

A user is required to allow the app required permissions that are defined as core permissions in order to ensure proper operation of the application. According to an embodiment, core functionalities whose permission to use is required include, but are not limited to:
Settings.ACTION_MANAGE_OVERLAY_PERMISSION
SYSTEM_ALERT_WINDOW
RECEIVE_BOOT_COMPLETED
BLUETOOTH
BLUETOOTH_ADMIN
ACCESS_COARSE_LOCATION
INTERNET

It is noted that although the above core functionalities account for Android operating system based mobile devices, the invention is not limited to such devices, and can be implemented to devices based on other operating system, e.g., iPhone OS (Ios).

A list of secondary permissions for proper operation of the app includes, but is not limited to:
VIBRATE
WAKE_LOCK
ACCESS_NETWORK_STATE
ACCESS_WIFI_STATE
READ_PHONE_STATE
CALL_PHONE
PROCESS_OUTGOING_CALLS
SEND_SMS

As described above, various features and functions of mobile devices are more distracting and adverse than others. Therefore, some features and functions of mobile devices are blocked less than others. For instance, in the vehicle-driver-mobile-device-use-prevention embodiment, a user may be permitted to access a dialer or a navigation software application although if an attempt to activate a forbidden software application is detected the screen is blocked immediately.

In order to determine when to restrict or allow driver interaction with the mobile device, the app communicates with an MU that in turn, informs the app whether or not the mobile device is in a forbidden context (such as motion of a vehicle in which the user moves or during predetermined working hours of the user). For instance, a vehicular MU constantly, e.g., once a second, transmits real-time data, e.g. vehicle speed and/or GPS coordinates, to the application which is installed on the driver's mobile device.

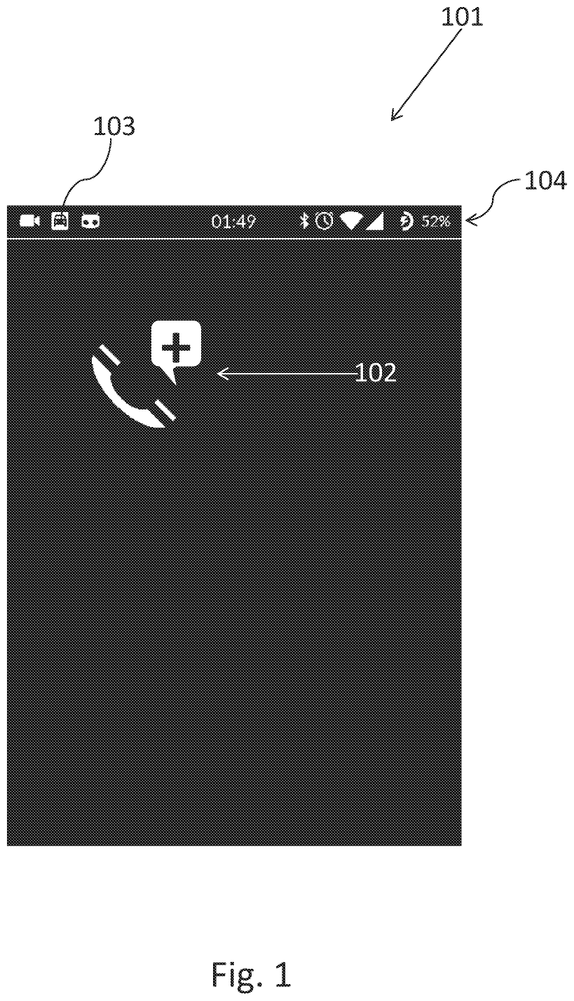

According to an embodiment, use of at least part of the touch screen of a mobile device is prevented. This is achieved by displaying a colored graphical overlay on the entire screen of the mobile device. FIG. 1 shows a colored graphical overlay 101 displayed on the screen of a mobile device according to an embodiment of the invention. The overlay is set as a system error window and is therefore displayed on the screen of the mobile device on top of all other windows. Although overlay 101 is presented visually, icon 102 represents an area that when touched allows the user to activate a permitted application (e.g., a dialer), while a touch on any other area of the screen will be intercepted by overlay 101. Each touch event is handled by the overlay. According to an embodiment, each touch event is accompanied by a short vibration of the mobile device. An icon 103 appears in the header bar 104 of the display of the mobile device, indicating that the app is running.

The overlay is displayed either when the MU indicates forbidden context, or upon receiving an override command from the remote server. The overlay is removed either when the MU indicates that the forbidden context ceased (e.g. the vehicle is stationary or the user left the factory); when there is no connection between the MU and the application; or upon receiving an override command from the remote server.

According to an embodiment, if before the screen is blocked a permitted software application was active (e.g. a navigation software application when driving), the overlay will be transparent (i.e., to allow visual view of the application), although touch interaction capability (for providing inputs from the user) with the navigation application via the touchscreen, will be prevented.

In the embodiment illustrated in FIG. 1, the user is allowed to initiate a phone call by launching the dialer of the mobile device from a dedicated icon 102 on the overlay. According to this embodiment, after the icon is touched, the overlay is removed for a predefined period of time, e.g., 30 seconds, during which only a dialer is displayed on the screen. If during this time the user attempts to close the dialer or to launch another software application on the mobile device, the overlay will be presented again. It is noted that while icon 102 grants access to a specific application and feature of the mobile device, other icons can be utilized to grant access to any other permitted application or feature of the mobile device, or to a list of permitted applications or features. Accordingly a plurality of icons can be displayed on top of overlay 101 in order to grant access to a plurality of permitted applications or features of the mobile device that are associated with each icon.

According to another embodiment of the invention, if a user attempts to interrupt communication between the application and the MU by deactivating the Bluetooth communication of the mobile device, the event is handled by the service component which reactivates the Bluetooth module, either with or without the user's permission, resulting in reestablishment of communication between the app and the MU.

According to an embodiment of the invention, upon detecting an attempt to interrupt communication with the MU, an alert is issued to a responsible party (e.g., a car fleet car officer or a factory team leader) in order to report the behavior of the user. According to yet another embodiment, updates are sent from the app to the MU periodically (e.g. once every 30 seconds), the updates regarding permitted and forbidden actions performed by the user.

### Monitoring Unit (MU)

The Monitoring Unit comprises:
a wireless communications element (e.g., Bluetooth Low Energy (BLE) module) for communicating with a mobile device;
a network communication module (e.g., GPRS) for communicating with the remote server that, (e.g., 3G cellular communication or Wi-Fi); and
a processing unit (e.g., a microcontroller) for processing and controlling data communication between the MU, the app and the remote server. According to an embodiment the processing unit is an Atmel® picoPower® microcontroller.

In the embodiments where the system is adapted for preventing use of mobile device by a vehicle driver, the MU further comprises a GPS receiver for detecting the location of the vehicle in which the MU is situated.

The processing unit runs a software program that allows the processing unit to perform at least the following actions:
pair with and connect to mobile devices that run the app;
autonomously communicate with the remote server for transferring various data, such as location, user information, pairing state, errors, software version and violations. This allows the MU to be monitored remotely in order to, for instance, log violations in case pairing isn't applied and during a forbidden context;
receive enforcement policy from an administrator (which can be an employer or any other personnel who requires the blocking provided by the system);
in relevant embodiments—obtain geographic data, including at least the position, speed and direction of the vehicle, and send the same to a connected and paired mobile device; and
enforce the policy on mobile devices connected thereto.

According to an embodiment, the software program on the MU runs in loop automatically and waits for the user's mobile device to connect upon context requirement (e.g., when a vehicle is started or when a user enters an area where connection to an MU is enabled). Once the mobile device connects it is recognized by the MU and registered (within the system) as connected to the MU, along with any other mobile devices that may be connected thereto. In the embodiment of preventing vehicle driver mobile device use no mobile device besides the driver's is able to connect with the MU.

An MU may be implemented in several embodiments. In one embodiment, the MU is integrated in a networking device (e.g., a router), thereby comprises built-in network connectivity. In case a networking device exists (e.g. a Wi-Fi router or an IP camera in a workspace) use of the system may be enabled by integrating the MU into the existing networking device using appropriate software components. By this full installation of the system is obviated.

In another embodiment, the MU is an independent entity comprising either wireless or wired connection to a networking device in addition to the wireless connectivity to mobile devices (e.g. Bluetooth). In yet another embodiment, the MU functions may be completely performed by the mobile devices of the system's users as part of the app, and thereby utilize the wireless connectivity of the devices for communicating with the server, alongside managing and enforcing blocking and disabling policies independently. It is noted that while other embodiments may be recognized for the MU as is apparent to the skilled person, they are not mentioned for sake of brevity. An MU is in no manner limited to the above demonstrated embodiments.

### Server

A custom backend server utilizes hardware and software modules to communicate with the MU and the app so as to receive indications therefrom. The indications can be used, inter alia, for statistical usage reports. The indications include, but are not limited to:
activation state of an MU, i.e. whether or not the MU is activated by a user entering the reception (e.g., Bluetooth) range of the MU with a mobile device with the app;
connection state between the MU and the app of each connected user;
login information of each user;
blocking state of the app, i.e., whether or not features of the mobile device are currently blocked by the app; and, in relevant embodiments
GPS position, velocity and license plate number of the vehicle.

According to an embodiment of the invention, the backend server further comprises a password protected webpage displaying a survey of MUs currently connected to the app, the current state of each and the timestamp of the last change in state of each connected user/device.

An enforcement policy that is to be enforced by the system, is determined by a party appointed therefor (i.e., system administrator). The enforcement policy is input to the system via an administrator interface in which the system administrator defines mobile device features and/or mobile-device-software-applications that are to be restricted and the context in which each feature is to be disabled. Enforcement policies can be based, for instance, on location of an MU (and of a mobile device connected thereto) and the time of day.

For instance, a policy may determine that only a dialer may be accessed and a previously running navigation software application may be visible (although not accessible). Another policy may determine that any connected mobile device is to enable only text messaging and incoming phone calls until 1 PM and from 2 PM onward. All other use attempts of mobile devices will be intercepted and reported to the remote server. A further policy may determine that any imaging apparatus of any mobile device is disabled at all times. Yet another policy may determine specific entities with which users may communicate via text/multimedia messages or phone conversations (for instance only fellow team members and emergency personnel). Obviously, other policies may be defined and enforced by the system of the present invention such as fully blocking use of any forbidden feature or forbidden application of any mobile device (while being in a forbidden context), or blocking use of specific features or applications of specific mobile devices which are forbidden, although for the sake of brevity only the above examples have been demonstrated.

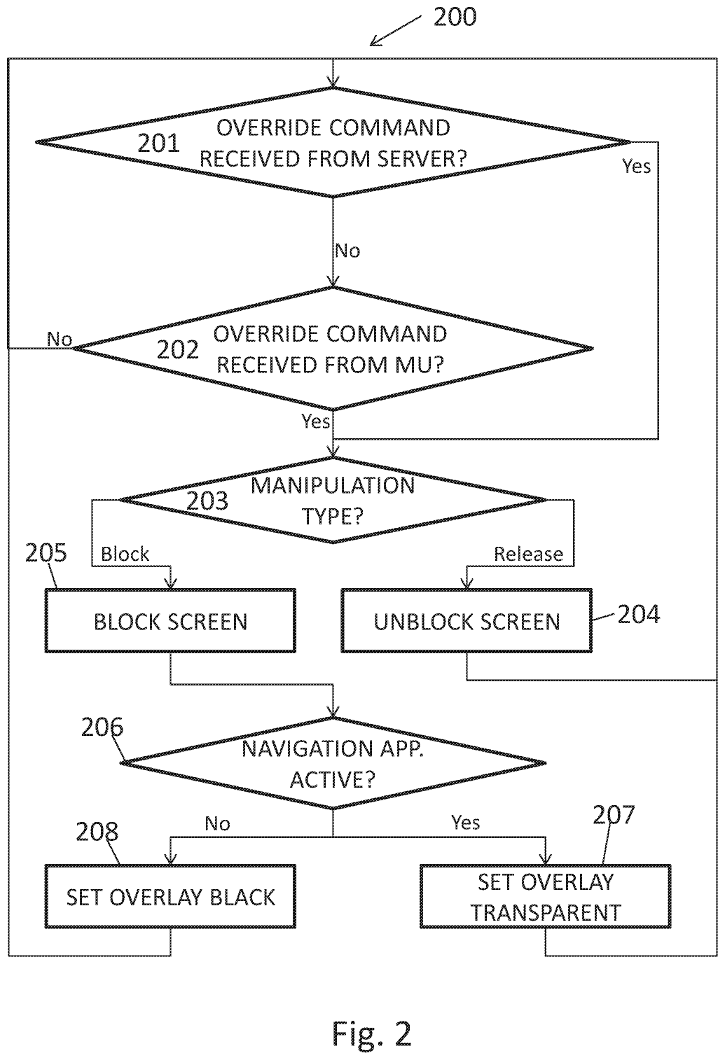

FIG. 2 shows a flowchart 200 describing screen block management, and actions that are performed according to the data which is constantly received from the MU, according to an embodiment. At the first stage 201, the application checks if an override command has been received from the server. If no such command was received from the server, then at stage 202 the application checks if a command was received from the MU. If no such action was received from the MU, then no action is taken. If a command was received either from the server or from the MU, then at stage 203 the overlay is manipulated according to the received command, as follows. If the command was to release the screen block, then at stage 204 the touch functionality of the screen is unblocked. If the command was to block the screen, then at stage 205 the touch functionality of the screen is blocked and touch events are intercepted. At the next stage 206, the app checks if one or more applications or features of the mobile device (e.g., a navigation software application) are permitted according to the enforcement policy and if any of them were active before stage 205, i.e. before the screen was blocked. If such an application was active then at stage 207 the overlay color is set to become transparent, in order to display the (window of) permitted application or feature on the screen. If no such application was active before stage 205, then at stage 208 the overlay is set to a dark color (e.g., black), thereby blocking visual display of any other application on the mobile device screen. It is noted that as long as no command arrives at the app from the MU or server, the blocking state (i.e. blocked or unblocked) is maintained.

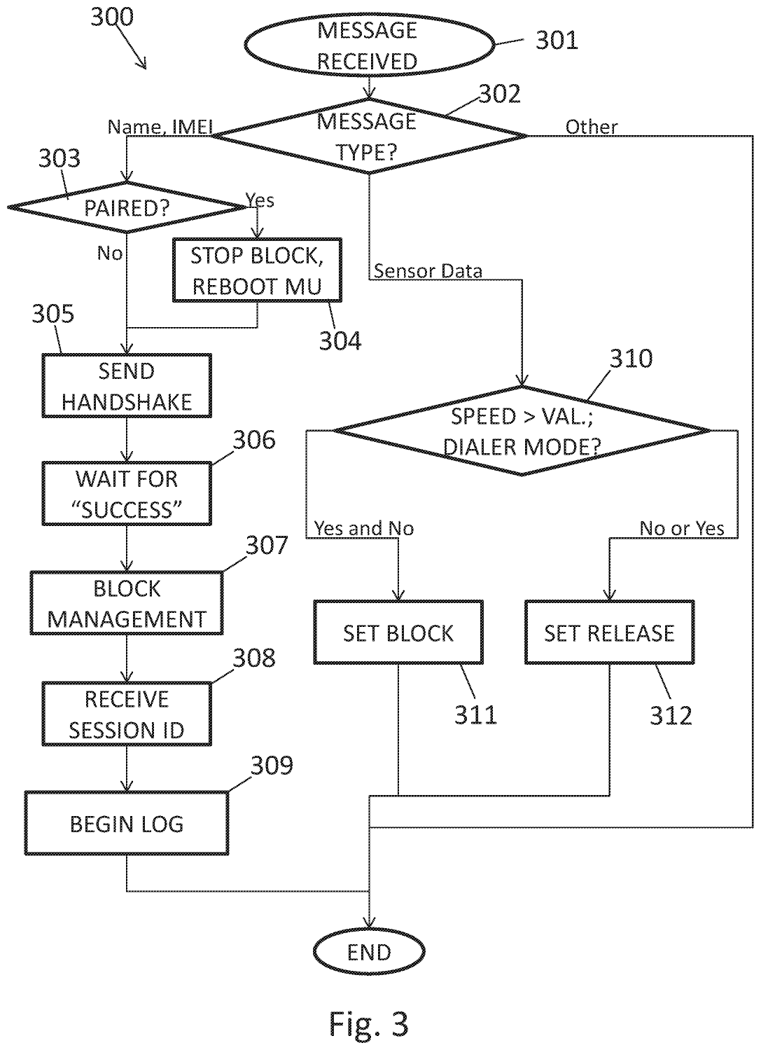

FIG. 3 shows a flowchart 300 describing the processing of a data message when such is received after communication is established with the MU. Every time a message is received from the MU it is handled accordingly. At the first stage 301, the app detects that a message has been received from the MU. At the next stage 302, the application checks what type the message is, i.e. name and International Mobile Equipment Identity (IMEI), real-time sensor data, or another message. If the message is a name and IMEI message then at stage 303, the application checks if the data is already paired. If the data is not paired, then at stage 305, a handshake message is sent from the app to the MU. If the data is paired, then at stage 304, block management and logging of all activity is stopped, the MU is rebooted, and the process continues to stage 305, i.e., a handshake message is sent to the MU. At the next stage 306, the process is at halt until a success indication is received back from the MU in response to the handshake message. Once success is indicated, at stage 307, the screen block management is initiated. Stage 307 comprises the process described hereinabove associated with FIG. 2. At the next stage 308, the app contacts the server and receives an ID of the session. According to an embodiment of the invention, stage 308 is repeated periodically, e.g. every 30 seconds, until an ID is received from the server. At the next stage 309, a log is created, recording all activity of the session.

Now returning to stage 302, if the message received from the MU consists of real-time sensor data (e.g., GPS data) then the process continues to stage 310, at which the application performs inspects the speed of the vehicle in addition to determining whether or not the user is in dialer mode (i.e., initiating a phone conversation). If the speed exceeds a predefined value (e.g., 1 MPH), and the user is not in dialer mode, then the process continues to stage 311, at which a block command is set and the touch functionality of the screen is blocked. If the speed of the vehicle does not exceed the predefined value or if the user is in dialer mode, then at stage 312 a release command is set by the application and the touch functionality of the screen is unblocked.

Again returning to stage 302, if the message received from the MU is neither a name and NEI or real-time sensor data, then no action is taken and the blocking process continues at the routine it was executing before the message was received.

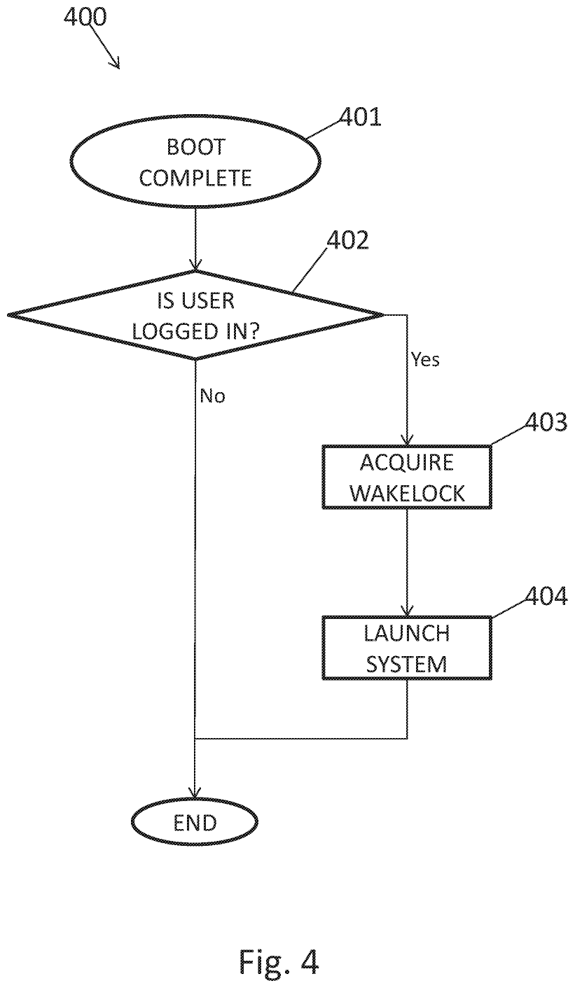

If at some point of the operation the mobile device is rebooted, the broadcast receiver component reinitiates communication and operation of the system. FIG. 4 shows a flowchart 400 describing the logic flow of the broadcast receiver component after the mobile device is rebooted. At the first stage 401, the mobile device boot is completed. At the next stage 402, the app (specifically the broadcast receiver component) checks if the user is logged in to the system. If the user is indeed logged in then at stage 403 WAKELOCK permission is acquired, i.e. the CPU is kept on, even when the mobile device is closed. At the next stage 404, the communication and operation of the system is launched. If at stage 402 the user is not logged in the no action is taken.

Restricting mobile device features and software applications can be ordered either by the server or by the device (according to the MU and the application, as explained above). According to an embodiment, orders from the server have higher priority than orders from the device. Therefore in case orders contradict each other (e.g. a release order received from the server at the same time as a block order from the mobile device) the order received from the server will be processed.

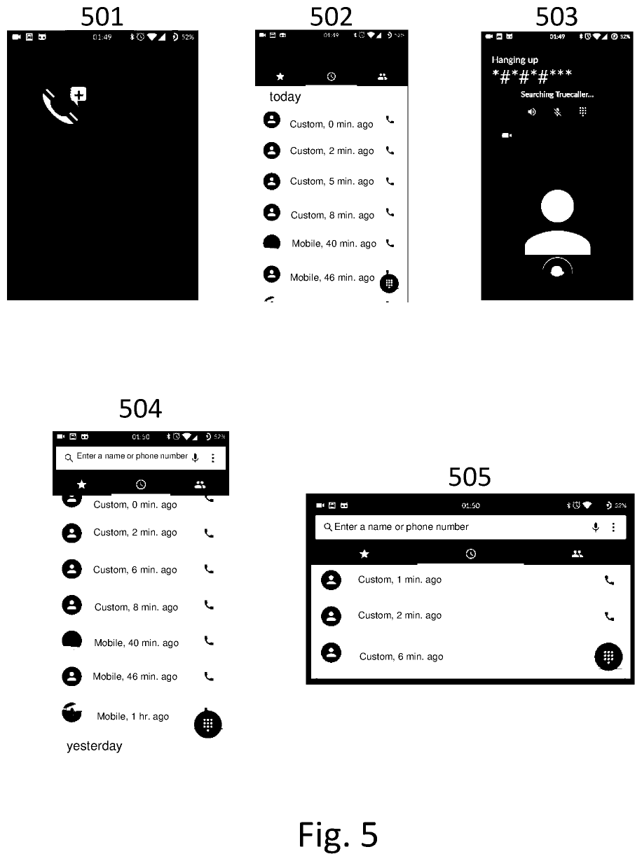

FIG. 5 illustrates a mobile device display at various operation states of the system according to an embodiment. State 501 shows a blocked screen with a dialing icon being touched (a grey circle indicating the touched point). State 502 shows a dialer being displayed on the screen of the mobile device, including a menu of recent phone calls. According to an embodiment of the invention a portion of the screen is locked (e.g. the top 30% of the screen), and touch events in this portion are blocked. State 503 shows a phone conversation being hung up. State 504 shows a trial to view a notification bar by sliding upwards (a black circle indicating the touched point), and the prevention of such action. State 505 shows the dialer of state 502 displayed on a horizontally oriented screen, indicating that the app is capable of handling mobile devices that are either horizontally or vertically oriented.

The above description provides a system and a method with which the use of mobile device features and software applications is restricted, wherein incoming data isn't intercepted by the system or by the server, rather they are not displayed or presented to the user, in contrast to other systems that require incoming data to be accumulated at the server.

Although embodiments of the invention have been described by way of illustration, it will be understood that the invention may be carried out with many variations, modifications, and adaptations, without exceeding the scope of the claims.

1. A system for contextually restricting use of features and software applications of a mobile device with a touchscreen, comprising:
a. a dedicated monitoring unit (MU) configured to communicate wirelessly with said mobile device; and
b. a dedicated software application (app) for mobile devices, installed in advance on said mobile device, said dedicated software application is adapted to:
b.1) connect wirelessly to, and communicate with the MU; and
b.2) when said mobile device is in a context that is forbidden according to a predefined enforcement policy, block features and applications of said mobile device, by disabling interaction capability via said touchscreen.

2. A system according to claim 1, wherein the enforcement policy is determined by a system administrator, the enforcement policy comprising forbidden features and/or forbidden software applications of the mobile device, and forbidden context for each forbidden feature and/or software application.

3. A system according to claim 1, further comprising a server configured to receive and send indications from and to the MU and the app.

4. A system according to claim 1, wherein the touchscreen of the mobile device is blocked by displaying an overlay on the touchscreen on top of all other windows, said overlay configured to intercept and block inputs resulting from any touch of the touchscreen of the mobile device.

5. A system according to claim 4, wherein the color of the overlay is dark, thereby blocking visual display of any other application from running on the mobile device screen.

6. A system according to claim 1, wherein in cases that a non-restricted feature or application is active, the overlay becomes transparent, thereby allowing visual view of the non-forbidden feature or application.

7. A system according to claim 1, wherein non-restricted features and software applications of the mobile device are accessible via an icon displayed on the overlay.

8. A system according to claim 1, wherein the app comprises:
a. an activity component being the graphical user interface, configured to allow the user to login to, and logout out of the system, and register to the system;
b. a service component, configured to manage the touchscreen blocking and connecting to the MU; and
c. a broadcast receiver component, configured to communicate with said MU.

9. A system according to claim 8, wherein after the mobile device is rebooted, the application automatically restarts and connects to the MU.

10. A system according to claim 1, wherein communication between the software app and the MU is Bluetooth communication.

11. A system according to claim 1, wherein the MU comprises a processing unit that runs a software program, adapted to pair with mobile devices that run the app.

12. A system according to claim 3, wherein the MU comprises a processing unit that runs a software program adapted to communicate with the remote server.

13. A system according to claim 1, wherein the forbidden context is selected from the following:
motion of a vehicle in which the user moves;
predetermined working hours of said user.

14. A system according to claim 13, wherein the enforcement policy determines that the restricted use is associated with data content.

15. A system according to claim 13, comprising:
a. a dedicated Monitoring Unit (MU) located inside the vehicle and configured to communicate wirelessly with the mobile device; and
b. a dedicated software application (app) for mobile devices, installed in advance on said mobile device and adapted to connect wirelessly and communicate with said MU and to block features and applications of the mobile device,
wherein upon receiving data from the MU indicating that the vehicle is in motion, the software application blocks the touchscreen of the mobile device from displaying predetermined data to, and from receiving inputs from, the user.

16. A system according to claim 13, wherein navigation and dialing software applications and features, are non-forbidden, when the mobile device is in forbidden context.

17. A system according to claim 15, wherein the MU comprises a GPS receiver, a cellular communication module, a Bluetooth communications element and a processing unit.

18. A system according to claim 17, wherein the processing unit runs a software program adapted to pair with mobile devices that run the app, communicate with the remote server, and send GPS data to a connected and paired mobile device.

19. A system for restricting adverse features and software applications of mobile devices comprising a system according to claim 1, wherein the forbidden context is locations throughout a workspace and/or specific work hours.
